(19) United States
(12) Patent Application Publication
(10) Pub. No.: US 2026/0065043 A1
(43) Pub. Date: Mar. 5, 2026

(54) Heterogeneous Neural Processing System with Line-Based Depth-First Scheduling for Generative AI Models

(71) Applicant: MEDIATEK INC., Hsinchu City (TW)

(72) Inventors: Shih-Wei Hsieh, Hsinchu City (TW); Ming-En Shih, Hsinchu City (TW); Ming-Hung Lin, Hsinchu City (TW); Ping-Yuan Tsai, Hsinchu City (TW)

(73) Assignee: MEDIATEK INC., Hsinchu City (TW)

(21) Appl. No.: 19/291,571

(22) Filed: Aug. 5, 2025

Related U.S. Application Data
(60) Provisional application No. 63/689,015, filed on Aug. 30, 2024.

(51) Int. Cl. G06N 3/063; G06N 3/0455; G06N 3/0475

(52) U.S. Cl. CPC G06N 3/063; G06N 3/0455; G06N 3/0475

(57) ABSTRACT

A heterogeneous neural processing system includes a first processor configured to execute encoding and decoding operations of an autoencoder, and a second processor configured to execute task-specific neural network operations with iterative processing. The processors execute computational tasks with synchronized data exchange to implement generative AI models. The first processor processes feature maps divided into lines of data with line-based depth-first scheduling, caches data in activation memory, and selects operations deeper in network hierarchy while handling branched inputs, outputs, and residual connections. An H-reuse cache stores boundary pixels between spatial segments, enabling concurrent execution of convolution and element-wise operations. A neural network conditioning device analyzes models to identify layer dependencies, applies search space constraints, performs iterative searches to generate fusion schedules, and selects optimal schedules based on external memory access and execution latency.

### CROSS REFERENCE TO RELATED APPLICATIONS

This application claims the benefit of U.S. Provisional Application No. 63/689,015, filed on Aug. 30, 2024. The content of the application is incorporated herein by reference.

### BACKGROUND

Generative artificial intelligence (AI) has demonstrated significant potential to revolutionize user experiences through its capability to generate images with exceptional perceptual quality. The ability of generative models to handle diverse input modalities enables various image synthesis and editing applications, such as text-to-image generation, high-resolution image restoration, and image inpainting. These applications typically employ sophisticated neural network architectures including latent diffusion models, autoencoder-based restoration systems, and multimodal conditioning networks.

Supporting generative AI applications on edge devices presents a range of significant technical challenges that demand novel solutions to simultaneously address multiple key constraints. These constraints include maintaining low latency, minimizing power consumption, reducing bandwidth usage, and optimizing silicon area. Edge devices such as smartphones, tablets, autonomous vehicles, and Internet of Things (IoT) systems face resource limitations that differ fundamentally from the ample resources available in cloud-based computing environments. For instance, edge devices must deliver real-time performance to power user-interactive applications, all while working within tight thermal budgets, limited battery capacities, and strict cost-sensitive manufacturing targets. These restrictions make it impractical to deploy high-power, large-area processing solutions typically used in data centers or cloud systems.

The area constraints of edge devices further complicate the situation. With limited on-chip memory and processing power, it becomes challenging to design neural processing units (NPUs) that can efficiently handle complex AI models without consuming excessive power or occupying too much silicon area. The silicon area allocated for neural processing is often just a small fraction of the total system-on-chip (SoC), which must also accommodate other vital components such as CPUs, graphics processors, communication interfaces, and power management units. As a result, the area available for NPUs limits the number of processing elements, the amount of on-chip memory, and the complexity of the control logic that can be incorporated.

In addition to these hardware challenges, edge devices must maintain compatibility with existing software ecosystems while providing sufficient computational power to support the growing complexity of modern neural network architectures. This trend toward increasingly sophisticated models amplifies the need for efficient processing architectures capable of handling complex neural network topologies. These architectures must not only minimize external memory access and reduce execution latency, but also ensure high hardware utilization within the tight area and power budgets typical of edge devices, enabling real-time AI performance without sacrificing battery life or overall device functionality.

### SUMMARY

An embodiment provides a heterogeneous neural processing system comprising a first processor used to execute an encoding operation and a decoding operation of an autoencoder, and a second processor used to execute a task-specific neural network operation that performs iterative processing. The first processor and the second processor execute computational tasks with synchronized data exchange to implement a generative AI model.

In some aspects, the encoding operation transforms input data into latent representations and the decoding operation reconstructs latent representations back into output data. An embodiment provides concurrent execution where the first processor executes the encoding operation and the decoding operation while the second processor concurrently executes the task-specific neural network operation on data of the same generative AI model.

In some aspects, line-based depth-first processing capabilities is provided where the first processor is further used to process feature maps of a neural network divided into a plurality of lines of data, cache the plurality of lines of data in an activation memory, and determine whether a required portion of the plurality of lines of data are cached in the activation memory and select operations that are deeper in a network hierarchy. In some aspects, the neural network comprises branched inputs, branched outputs, and residual connections processed within a fused layer stack.

In some aspects, the first processor comprises an H-reuse cache used to store boundary pixels between adjacent spatial segments. In some aspects, the first processor is further used to execute a convolution and an element-wise operation concurrently, and the element-wise operation comprises addition and/or concatenation. An embodiment provides ping-pong buffers used to fetch a next data segment while a current segment is being processed.

In some aspects, a neural network conditioning device is used to analyze a neural network model to identify layer dependencies and fusion boundaries, apply constraints to a search space based on memory capacity and processing capacity to define fusion configurations, perform an iterative search within the search space to generate a plurality of fusion schedules, and select a fusion schedule from the plurality of fusion schedules based on external memory access and execution latency.

In some aspects, the task-specific neural network operation comprises denoising operations performed by a U-Net architecture. In some aspects, the task-specific neural network operation comprises a conditioning operation that encodes semantic vectors or textual token embeddings into latent space representations, or attention mechanisms having query, key, and value components.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The following drawings form a part of the present specification and are included to further demonstrate certain aspects of the present disclosure. The disclosure may be better understood by reference to one or more of these drawings in combination with the detailed description of specific embodiments presented herein.

FIG. 1A illustrates a generative AI model architecture operating in both pixel space and latent space.

FIG. 1B illustrates a heterogeneous neural processing system for executing generative artificial intelligence models according to an embodiment.

FIG. 2A illustrates the overall architecture of the MAE (Mini AutoEncoder) chip according to an embodiment.

FIG. 2B illustrates the MAE data flow during computation according to an embodiment.

FIG. 3A illustrates a layer fusion with branch example that represents a typical neural network stack with complex connectivity patterns.

FIG. 3B illustrates the line-based depth-first execution methodology according to an embodiment.

FIG. 3C illustrates the scheduling order and memory management according to an embodiment.

FIG. 4A demonstrates performance comparison results showing external memory access reduction using depth-first fusion with branch handling with respect to L1 size.

FIG. 4B demonstrates performance comparison results showing latency reduction using depth-first fusion with branch handling with respect to bandwidth.

FIG. 5A illustrates the data flow architecture within the convolution unit and add/concatenation unit according to an embodiment.

FIG. 5B illustrates a simplified architectural overview of the direct link between convolution unit and A/C unit according to an embodiment.

FIG. 6 illustrates the convolution line processing workflow with local reuse according to an embodiment.

FIG. 7A illustrates the effectiveness of H-reuse caching compared to re-reading data from L1 memory.

FIG. 7B demonstrates performance comparison results showing latency reduction with H-reuse cache and direct link.

FIG. 8A illustrates an optimization challenge example for scheduling DNN models with multiple branches.

FIG. 8B illustrates global scheduling optimization according to an embodiment.

FIG. 9A demonstrates performance analysis results showing the EMA-latency feasible region analysis.

FIG. 9B demonstrates performance comparison results showing EMA and latency improvements.

### DETAILED DESCRIPTION

Heterogeneous neural processing systems represent a paradigm shift from traditional homogeneous architectures by incorporating multiple specialized processing units, each optimized for distinct computational workloads. Unlike conventional single-processor approaches that attempt to handle all neural network operations with a unified architecture, heterogeneous systems strategically distribute computational tasks across processing units with complementary capabilities. This architectural approach recognizes that different neural network operations have vastly different computational characteristics, memory access patterns, and performance requirements that cannot be optimally served by a single processing unit design.

In heterogeneous neural processing systems, a general neural processing unit (NPU) typically provides high throughput and low latency for computationally intensive operations, while a specialized tiny NPU handles specific workloads with high efficiency and low power consumption. The general NPU is designed with large-scale parallel processing capabilities, substantial on-chip memory, and flexible instruction sets to accommodate diverse neural network architectures and rapidly changing algorithmic requirements. Conversely, the specialized tiny NPU is optimized for specific operation types with dedicated hardware blocks, streamlined data paths, and minimal control overhead to maximize efficiency within stringent area and power budgets. Each task is allocated to the most efficient processing core to exploit the complementary strengths of different processing units through intelligent workload distribution algorithms. This task allocation process considers factors including computational complexity, memory bandwidth requirements, data dependencies, and real-time constraints to determine optimal processor assignment. The heterogeneous approach enables simultaneous execution of different neural network components, allowing overlapped computation and improved resource utilization compared to sequential processing approaches.

For instance, when deploying generative diffusion models, the processing cores can operate collaboratively with a specialized tiny NPU handling autoencoder operations and a general NPU executing latency-dominant denoising networks and conditioning modules. The autoencoder operations, which involve relatively regular computational patterns and can benefit from specialized optimization, are well-suited to the tiny NPU's focused architecture. Meanwhile, the complex, iterative denoising processes and multimodal conditioning operations require the flexibility and computational power provided by the general NPU. This collaborative processing approach enables efficient resource utilization while maintaining the performance characteristics required for real-time generative AI applications.

However, designing specialized tiny NPUs presents unique challenges due to very limited area budgets that inherently restrict the number of multiply-accumulate (MAC) units and the amount of on-chip memory available. This constraint creates two primary technical problems. First, reduced on-chip memory necessitates more energy-consuming external memory access, where energy consumed by DRAM access can account for a major portion of the total energy consumption in layer-by-layer scheduling approaches, affecting low-power objectives. Second, temporal under-utilization can occur when calculations are limited by input/output bandwidth or non-MAC operations, limiting overall performance and hardware efficiency.

Traditional neural network processing approaches typically employ layer-by-layer execution scheduling, where complete feature maps are computed for each layer before proceeding to subsequent layers. While this approach is conceptually straightforward, it requires substantial intermediate storage and results in frequent external memory access that dominates power consumption in resource-constrained implementations. Layer-by-layer scheduling also fails to exploit opportunities for overlapping computation and memory access that could improve overall efficiency.

Depth-first scheduling concepts have been proposed as alternatives to layer-by-layer approaches, where feature maps are divided into tiles and processed in depth-first order to reduce on-chip memory usage by immediately consuming produced data. Prior depth-first scheduling implementations have demonstrated effectiveness in reducing external memory access compared to traditional layer-by-layer approaches by prioritizing computation of deeper layers within fused layer stacks as soon as input data becomes available.

Existing depth-first scheduling techniques face limitations when applied to modern neural network architectures. As neural network topologies become more complex with branched inputs, branched outputs, and residual connections, prior depth-first scheduling methods typically revert to less efficient layer-by-layer scheduling when encountering such branching patterns. This limitation restricts the potential fusion space and prevents these methods from achieving optimal memory access reduction for contemporary neural network architectures commonly used in generative AI applications.

Furthermore, conventional solutions lack mechanisms to enable concurrent execution of different types of operations, such as convolution and element-wise operations, leading to underutilization of processing resources and increased latency. Traditional scheduling methods also do not provide comprehensive optimization frameworks that can handle the exponential search space complexity that arises when optimizing fusion decisions for networks with multiple branching points.

To address the above-described challenges, the following disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

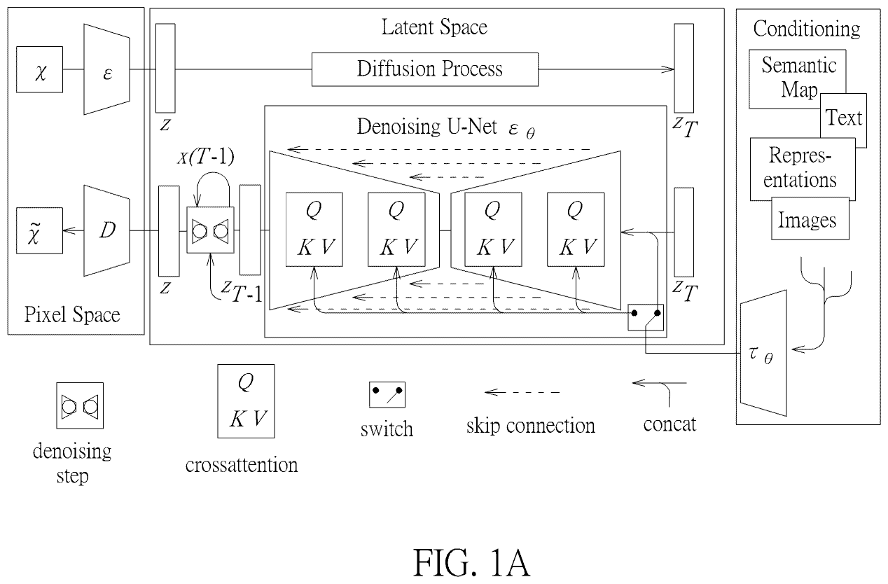

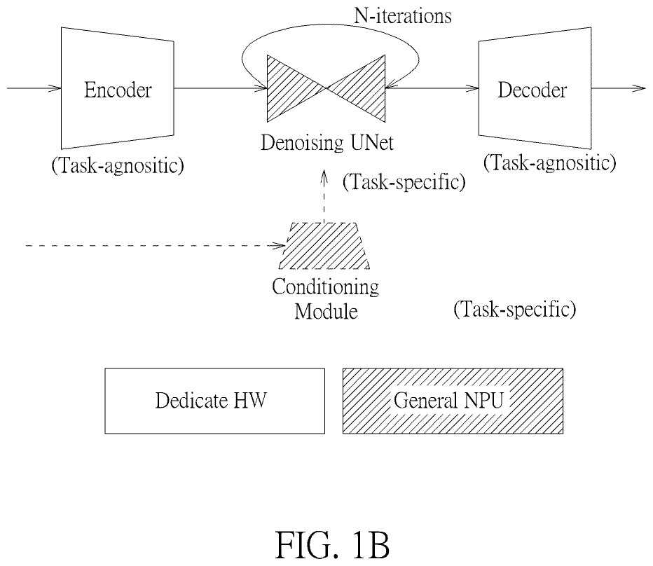

FIG. 1A illustrates a heterogeneous neural processing system for executing generative artificial intelligence models according to an embodiment. The system shows the mapping between a model and a corresponding hardware.

The model architecture in FIG. 1A represents a generative AI system operating in both pixel space and latent space. The model comprises an encoder (E) located in the pixel space that transforms input data (x) from pixel representation into a compressed latent representation (z). This encoding operation reduces the dimensionality of the input data while preserving essential features. The model also includes a decoder (D) positioned in the pixel space that reconstructs the latent representation back into pixel space output (x). The decoder performs the inverse operation of the encoder, expanding the latent representation into full-resolution output data.

The model, operating within the latent space, includes a denoising U-Net that performs iterative denoising operations on the latent representation (z). The U-Net processes the data through multiple stages with skip connections, crossattention mechanisms, and various neural network operations including switches and concatenations. The parameter to represents the time-conditioned denoising U-Net model. The denoising process is repeated N iterations to progressively refine the latent representation, with each iteration guided by a noise parameter To that controls the denoising schedule. Within the U-Net architecture, the Query (Q), Key (K), and Value (V) components of the cross-attention mechanism enables text-conditional generation. The Q vectors are derived from the latent image representation, and K and V vectors are generated from the conditioning information such as text embeddings, allowing the model to attend to relevant semantic information during the denoising process. Additionally, the model incorporates a conditioning module that serves as a task-specific component for incorporating external conditioning information such as semantic maps, text representations, or other control signals. The conditioning module influences the denoising process to guide the generation toward desired outputs.

The hardware solution of the above described model is shown in FIG. 1B, which implements a heterogeneous processing system that optimally allocates different model components to specialized processing units. The system includes dedicated hardware comprising a specialized neural processing unit (NPU) specifically designed to perform operations of the encoder and decoder. The dedicated hardware can be optimized for the task-agnostic autoencoder, comprising the encoder and the decoder, to provide high efficiency and low power consumption. The system also incorporates a general NPU used as a general-purpose neural processing unit to handle the denoising U-Net and conditioning module. The general NPU provides higher throughput and lower latency for the computationally intensive and task-specific operations.

The heterogeneous system employs the complementary strengths of each processing unit, where task-agnostic components benefit from specialized hardware optimization while task-specific components utilize general-purpose processing for flexibility and performance. The workload distribution enables optimal resource utilization across the entire generative AI pipeline, and concurrent execution allows parallel processing of different model components. The system processes data by having input data enter the encoder on the dedicated hardware, with the encoded latent representation flowing to the denoising U-Net on the general NPU where conditioning information is incorporated during the denoising process. The refined latent representation then returns to the decoder on the dedicated hardware, and the final output is generated in pixel space. This architecture enables efficient deployment of complex generative AI models on edge devices by balancing specialized optimization with general-purpose flexibility, ensuring both high performance and energy efficiency.

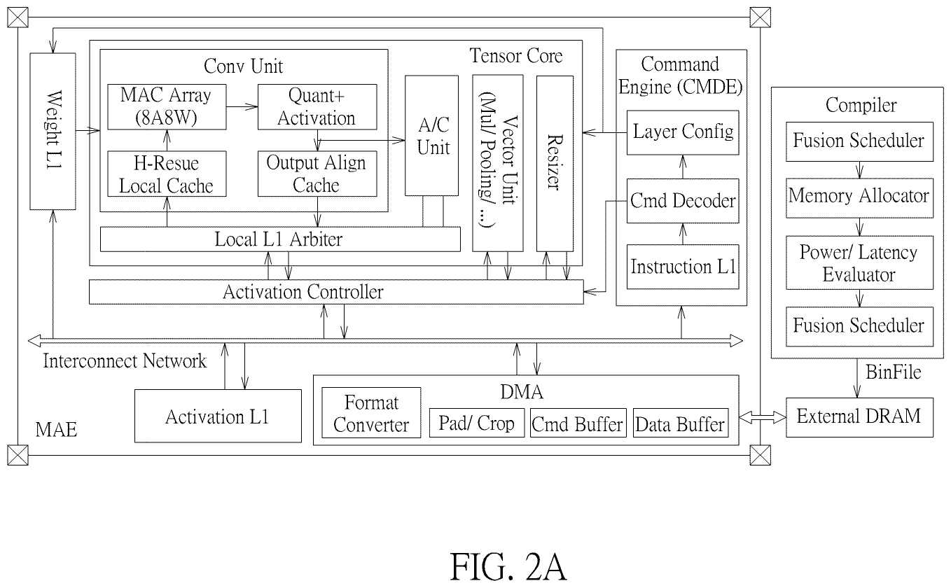

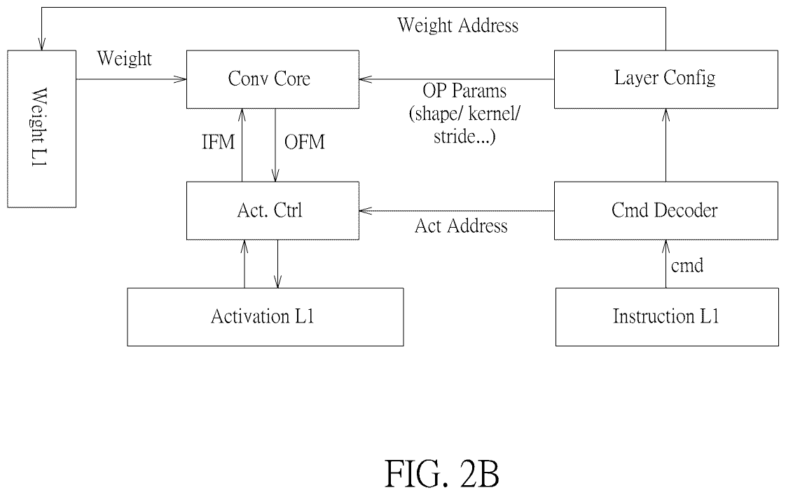

FIGS. 2A and 2B illustrate the architecture of the MAE (Mini AutoEncoder) chip, which includes on-chip memory for efficient neural network processing on edge devices.

FIG. 2A illustrates the architecture of the MAE chip according to an embodiment. The central processing core comprises a tensor core that includes a convolution unit, an add and concatenation unit (A/C unit), a vector unit for element-wise operations, and a resizer. The convolution unit incorporates a 576 8-bit MAC (multiply-accumulate) array capable of handling convolutions with various dilation rates, strides, and kernel sizes. The MAC array generates quantized and activated outputs that are sent to an output align cache, which formats the data as 4 pixels per word to match the L1 data format. The convolution unit includes an H-reuse local cache that stores boundary pixels when processing each line, reducing the need to access the primary activation L1 memory and improving bandwidth utilization for strided and depth-wise convolutions.

The output from the convolution unit is directly linked to the A/C Unit through a dedicated connection path, enabling concurrent execution of convolution and element-wise operations to minimize core idle time during residual addition or concatenation operations. This direct linkage reduces latency by eliminating pipeline stalls between sequential operations. The tensor core components are coordinated by a Local L1 Arbiter that manages memory access conflicts and ensures efficient utilization of the shared L1 bandwidth between different processing units.

The control infrastructure includes a command engine (CMDE) that comprises a layer configuration module, a command decoder, and an instruction L1 memory. The command engine determines appropriate layer configurations including parameters such as input/output dimensions, quantization parameters, and weight addresses. The command system also specifies the temporal execution order of each line and its corresponding activation L1 address. To prevent stalls between command switches, the CMDE prefetches the next set of commands concurrently with ongoing calculations, ensuring continuous operation without processing interruptions.

The compiler and scheduling system implements a multi-objective scheduler with optimized iterative search. This system includes a fusion scheduler that determines optimal layer fusion layouts, a memory allocator that manages address assignments for various operation heights and live ranges, and a power/latency evaluator that assesses performance trade-offs. The compiler generates binary coding that produces a binary file (BinFile) including all pre-compiled weights, commands, and configurations, which is stored in external DRAM for runtime access.

The memory subsystem includes the main activation L1 memory and a comprehensive DMA (Direct Memory Access) system featuring a format converter, pad/crop operations, command buffer, and data buffer for efficient data movement between on-chip and external memory. The entire system is connected through an interconnect network that facilitates communication between all components and maintains high bandwidth and low latency data transfers.

FIG. 2B illustrates the MAE data flow during computation that demonstrates the line-based depth-first layer fusion with branch handling capability. The data flow shows the interaction between weight L1 memory, the convolution core (Conv Core) with input feature maps (IFM) and output feature maps (OFM), and the activation control system. The system processes operational parameters including shape, kernel, and stride information through the layer configuration module, whereas the command decoder manages command execution based on instructions from the Instruction L1 memory. The convolution core receives weight data and operational parameters (OP Params) including shape, kernel, and stride specifications through the weight address path from the layer configuration module.

The activation control (Act. Ctrl) module coordinates data flow by managing activation addresses (Act Address) that determine where intermediate data is stored and retrieved from the activation L1 memory. This coordination provides that the line-based processing approach can efficiently handle branched inputs, outputs, and residual connections within fused layer stacks. The data flow architecture represents advancement over traditional layer-by-layer scheduling approaches by enabling finer-grained control over data movement and processing order, allowing portions of deeper layers to begin processing before entire intermediate layers are completed while maintaining computational efficiency and reducing memory footprint requirements.

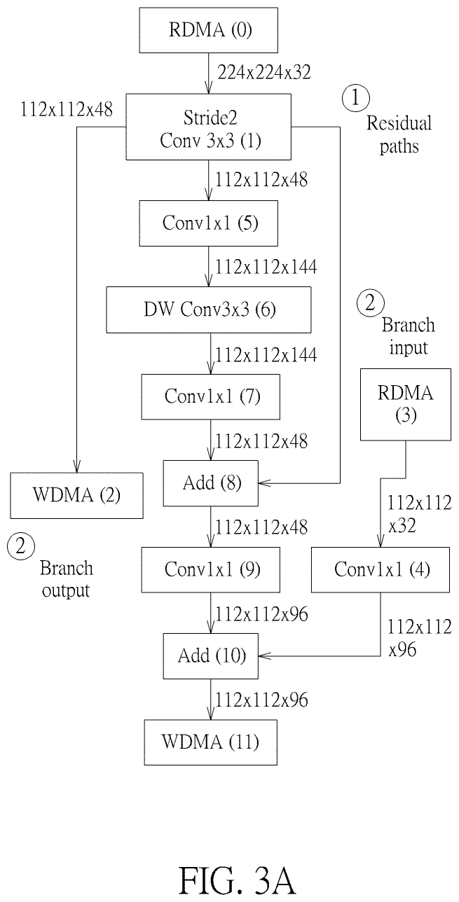

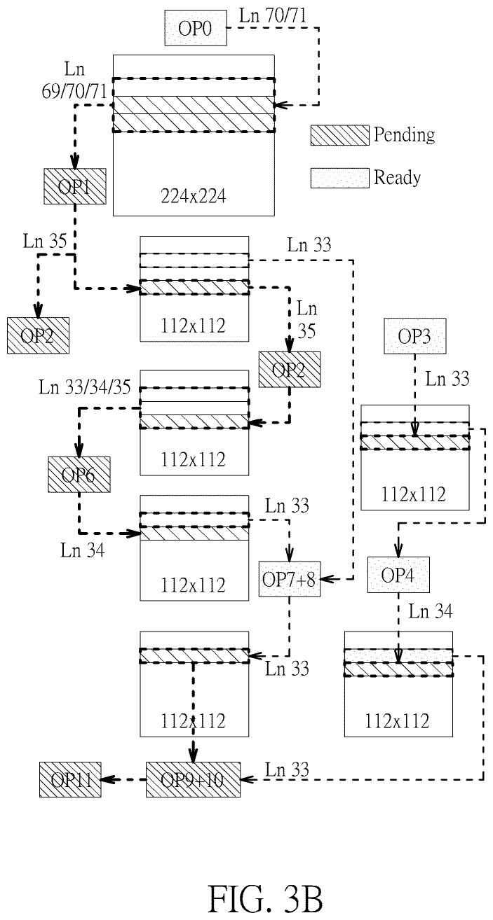

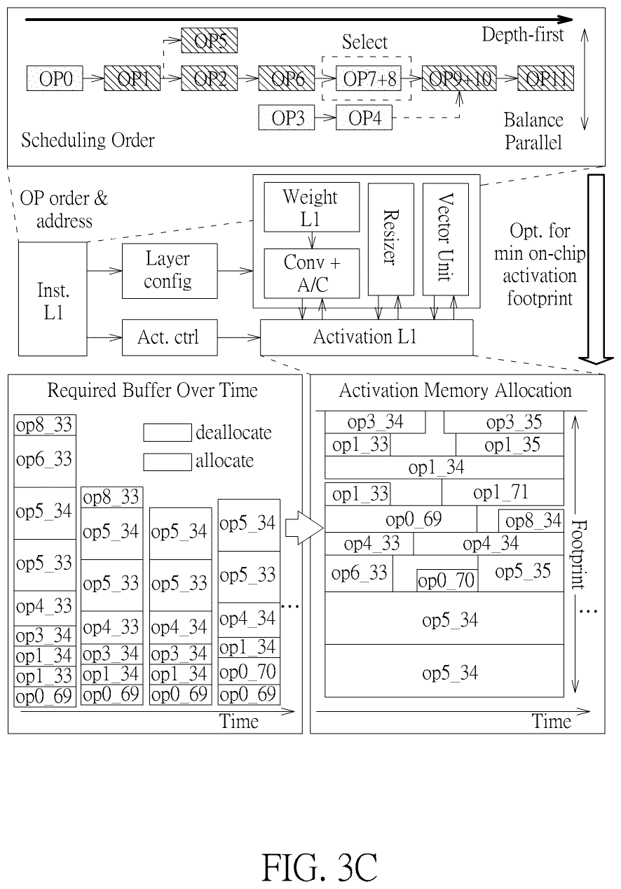

FIG. 3A illustrates the layer fusion with branch example that represents a typical neural network stack with complex connectivity patterns. The network begins with a remote direct memory access (RDMA) operation (0) that loads a 224×224×32 input tensor, followed by a stride2 convolution 3×3 (Conv3×3) operation (1) that reduces the spatial dimensions to 112×112×48. The network then includes a convolution 1×1 (Conv1×1) operation (5) and a depth-wise convolution 3×3 (DW Conv3×3) operation (6) processing data with dimensions 112×112×144. A critical aspect of this topology is the presence of residual paths, indicated by the arrows connecting different layers, and branch input points where data from multiple sources converges. The network also demonstrates branch output scenarios where a single layer's output feeds into multiple subsequent operations, including convolution 1×1 operations (7, 9, 4) and add operations (8, 10). The final outputs are processed through write direct memory access (WDMA) operations (2, 11) that write results back to memory. This complex network topology with multiple branching points and residual connections represents the type of challenging architecture that prior depth-first scheduling methods could not handle efficiently, typically requiring a reversion to less optimal layer-by-layer scheduling approaches.

FIG. 3B illustrates the line-based depth-first execution method and scheduling system that enables efficient processing of the complex topology shown in FIG. 3A. This method divides feature maps into lines of data, with each line serving as a computational unit. Operations are indicated as OP0 through OP11, corresponding to the network layers shown in FIG. 3A, and are processed according to line availability rather than strict layer-by-layer execution. The diagram shows how lines are tracked with specific line numbers (Ln 69/70/71, Ln 35, Ln 33, etc.) and demonstrates the temporal execution where some operations show “pending” status and others are “ready”. This approach allows operations deeper in the network hierarchy to execute as soon as their required input lines become available, rather than waiting for entire feature maps to be computed.

This line-based method allows operations deeper in the network hierarchy to execute as soon as their required input lines become available, rather than waiting for entire feature maps to be computed. The scheduling system evaluates at each time step which operations have all their required input lines available in the activation memory and selects operations that are deeper in the network hierarchy while maintaining balance across parallel branches. This depth-first prioritization with branch balancing prevents any single branch from dominating the computation resources and ensures efficient utilization of the available processing capabilities. The diagram shows complex data dependencies where operations like OP5, OP6, OP7+8, and OP9+10 are coordinated based on line availability. Operations OP7+8 and OP9+10 are shown as combined operations, indicating that these represent fused operations that can be executed together when their input dependencies are satisfied. The line-based processing methodology represents a fundamental shift from traditional tile-based or layer-based approaches, enabling finer-grained scheduling decisions that can accommodate the complex data dependencies present in branched network architectures. This method can be particularly effective for neural networks with residual connections and branching patterns, as it allows portions of deeper layers to begin processing before entire intermediate layers are completed, reducing the memory footprint required for intermediate activations while maintaining computational efficiency.

FIG. 3C illustrates the scheduling order and memory management strategy that coordinates the depth-first execution. The scheduling order is managed within the instruction L1 memory, which maintains a queue of operations (OP0→OP1→OP2→OP6→OP7+8→OP9+10→OP11) that balances depth-first prioritization with parallel branch execution to prevent any single branch from dominating computation. The architecture includes sophisticated memory management with components including: a weight L1 memory that stores convolution weights and parameters, a convolution and add/concatenate (Conv+A/C) unit that performs convolution with add/concatenation functionality, an activation L1 memory that holds intermediate activation data and feature maps, an instruction L1 memory that manages operation scheduling and control flow, layer configuration modules that manage operation parameters, an activation control block that coordinate data flow, a resizer that handles dimensional adjustments of feature maps, and a vector unit for element-wise operations. These components coordinate to minimize the on-chip activation footprint while maintaining efficient data flow throughout the processing pipeline.

The required buffer over time section shows how memory allocation and deallocation are managed dynamically to accommodate the varying memory requirements of different operations over time. This illustration demonstrates temporal memory usage patterns where different operations (op8_33, op5_34, op5_33, op4_33, op4_34, etc.) require varying amounts of buffer space at different execution phases. The system allocates memory blocks when operations begin processing their data and automatically deallocates these blocks when the intermediate results are no longer needed by subsequent operations in the fusion stack. This dynamic memory management approach allows multiple operations with overlapping execution windows to share limited on-chip memory resources efficiently, with the allocator tracking live ranges of different data buffers to minimize peak memory consumption while ensuring all required intermediate data remains available when needed.

The activation memory allocation demonstrates how the activation L1 memory manages memory for cached lines of various heights and overlapping live ranges. The memory allocator assigns addresses to minimize the required footprint, with different operations (op0_33, op1_34, op3_34, etc.) allocated specific memory regions that are efficiently reused as operations complete. The timeline shows how memory allocation evolves, with some regions being deallocated while others are allocated for optimal memory utilization throughout the execution process. The demonstrated line-based depth-first method with branch handling extends the potential fusion space compared to traditional methods, enabling the system to achieve reductions in external memory access and maintains efficient utilization of processing resources, showing advancement over prior depth-first scheduling techniques.

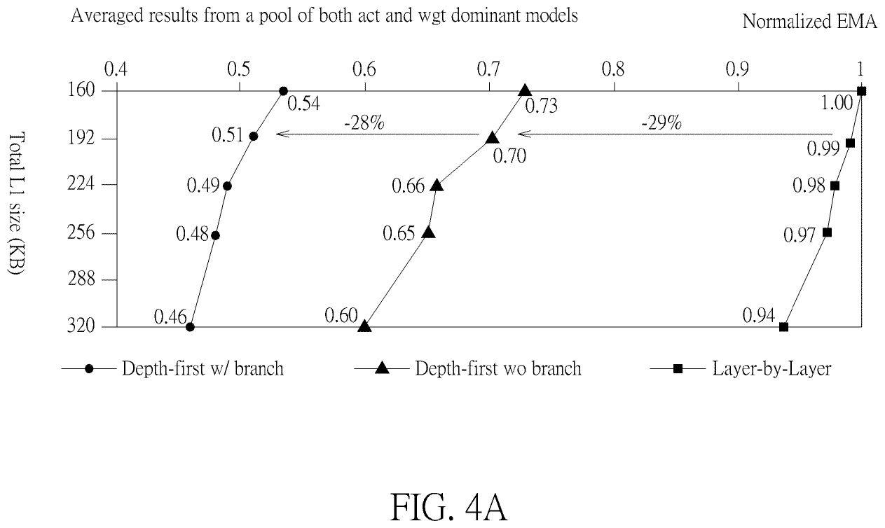

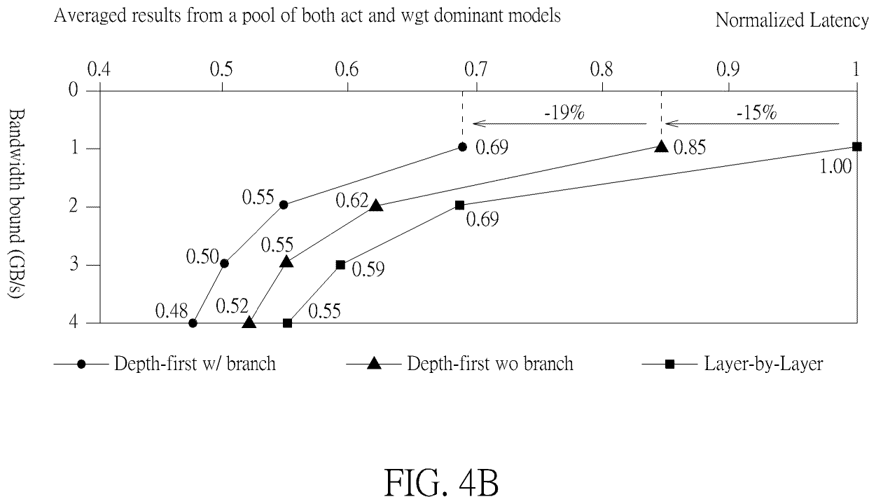

FIG. 4A demonstrates EMA reduce using depth-first fusion with branch with respect to L1 size showing results from a pool of both activation-dominant and weight-dominant neural network models. The horizontal axis represents the normalized EMA ranging from 0.4 to 1.0, while the vertical axis shows the total L1 size in kilobytes from 160 KB to 320 KB. Three distinct scheduling approaches are compared: depth-first with branch handling, depth-first without branch handling, and traditional layer-by-layer scheduling. The depth-first with branch handling approach demonstrates EMA reduction, achieving 28% improvement compared to depth-first without branch handling and 29% improvement compared to layer-by-layer scheduling. The results show that across different L1 memory sizes, the proposed branch-aware depth-first fusion consistently outperforms both conventional approaches, with performance values ranging from 0.46 to 0.54 for the proposed method compared to 0.60 to 0.73 for depth-first without branch and 0.94 to 1.00 for layer-by-layer scheduling.

FIG. 4B illustrates latency reduce using depth-first fusion with branch with respect to bandwidth showing latency improvements with respect to bandwidth constraints. The horizontal axis represents normalized latency from 0.4 to 1.0, while the vertical axis shows bandwidth bound in GB/s from 0 to 4. Similar to FIG. 4A, three scheduling approaches are compared using the same marker conventions. The proposed depth-first with branch handling approach achieves substantial latency reductions of 19% compared to depth-first without branch handling and 15% compared to layer-by-layer scheduling. The performance data shows that the proposed method maintains latency values between 0.48 and 0.69 across different bandwidth constraints, while depth-first without branch handling ranges from 0.50 to 0.85, and layer-by-layer scheduling approaches the baseline value of 1.00. The results demonstrate that bandwidth-bound scenarios particularly benefit from the proposed approach, with more improvements observed at lower bandwidth constraints.

The ability to handle branched inputs, outputs, and residual connections within fused layer stacks enables deeper fusion than prior depth-first approaches that typically reverted to less efficient layer-by-layer scheduling when encountering complex network topologies. The averaged results across both activation-dominant and weight-dominant models demonstrate the general applicability and robustness of the proposed approach across different neural network architectures commonly used in generative AI applications.

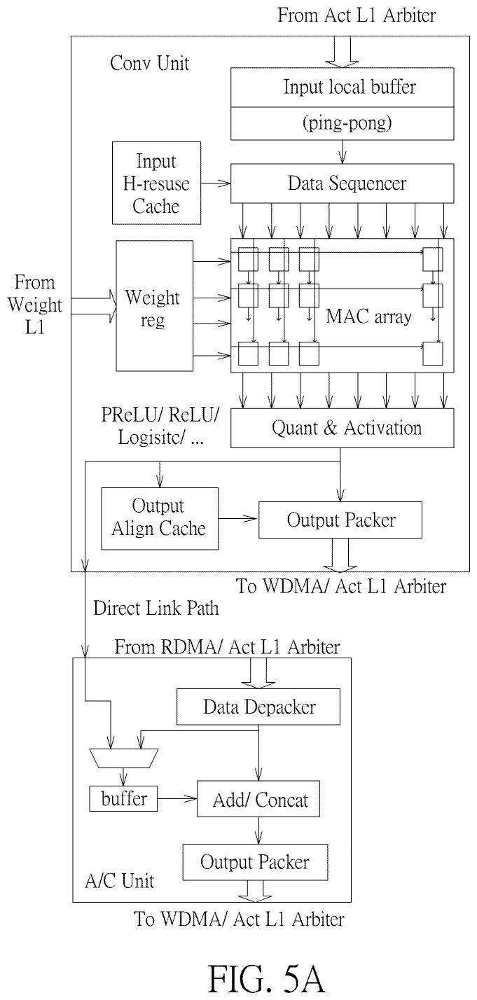

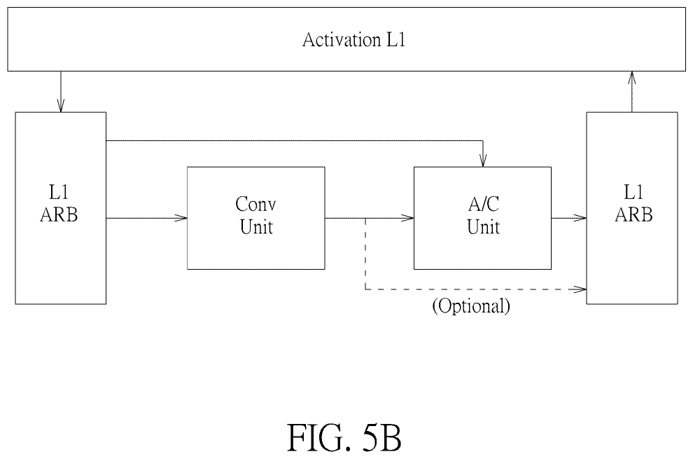

FIG. 5A illustrates the data flow architecture within the convolution unit and A/C unit according to an embodiment. This figure demonstrates the H-reuse cache mechanism and direct link path that enable concurrent execution of convolution and element-wise operations to reduce latency and improve bandwidth utilization.

The upper section shows the convolution unit data flow, which receives input from the activation L1 arbiter. The convolution unit incorporates an input local buffer that employs a ping-pong mechanism, with one buffer set fetching the next data segment from the activation L1 while the other set is connected to the MAC array, ensuring continuous processing without pipeline stalls. The Input H-reuse Cache stores boundary pixels between adjacent spatial segments to avoid re-reading overlapping data from the primary L1 memory.

The data sequencer coordinates the flow of input data to the MAC array, which processes spatial segments of 8 pixels in parallel while different segments are mapped to temporal execution. Weight data is supplied from the weight L1 memory through weight registers to the MAC array. The MAC array generates accumulated sums that are processed through quantization and activation functions (PReLU/ReLU/Logistic) before being sent to an output alignment cache. The output alignment cache formats the processed data to match the L1 data format requirements. The output is then packaged by an Output Packer before being sent to the WDMA (Weight Direct Memory Access) and/or activation L1 arbiter for storage or further processing.

The lower section demonstrates the A/C unit and the direct link path that enables concurrent execution between the convolution unit and A/C unit. Data can flow directly from the convolution unit to the A/C unit through the direct link path, bypassing intermediate storage and enabling simultaneous execution of convolution and element-wise operations. Alternatively, data can arrive at the A/C unit from RDMA (Remote Direct Memory Access) and/or activation L1 arbiter. The processed results can be formatted by an output packer and sent to the WDMA and/or activation L1 arbiter.

FIG. 5B illustrates a simplified architectural overview of the direct link between convolution unit and A/C unit according to an embodiment. The figure shows the connectivity and data flow paths. The activation L1 memory serves as the central data repository for the system. Two L1 arbiters (L1 ARB) manage access to the shared activation L1 memory, providing conflict-free operation when multiple units require simultaneous memory access. The convolution unit and A/C unit are positioned with the direct link path, showing the direct connection that enables data to flow from the convolution unit output directly to the A/C unit input without requiring intermediate storage in the activation L1 memory.

There is also an optional path that represents the data flow through the activation L1 memory when direct linking is not used. This architectural overview demonstrates the flexibility of the architecture to operate in either direct link mode for maximum efficiency or through conventional memory-mediated data flow when required by specific operation sequences. The L1 arbiters coordinate access patterns to prevent memory conflicts and ensure efficient bandwidth utilization across all processing units. In addition, this architecture minimizes core idle time during residual addition or concatenation operations by allowing the convolution unit and A/C unit to operate concurrently. An L1 arbiter resolves memory contention at runtime, ensuring conflict-free and efficient use of shared L1 bandwidth between the different processing units. The combination of H-reuse caching and direct link connectivity reduces average latency compared to conventional approaches that process convolution and element-wise operations sequentially. The ping-pong buffer mechanism ensures that line processing remains continuous and free from pipeline stalls, while the H-reuse cache specifically targets the reduction of redundant memory accesses that occur when processing overlapping spatial regions in convolution operations.

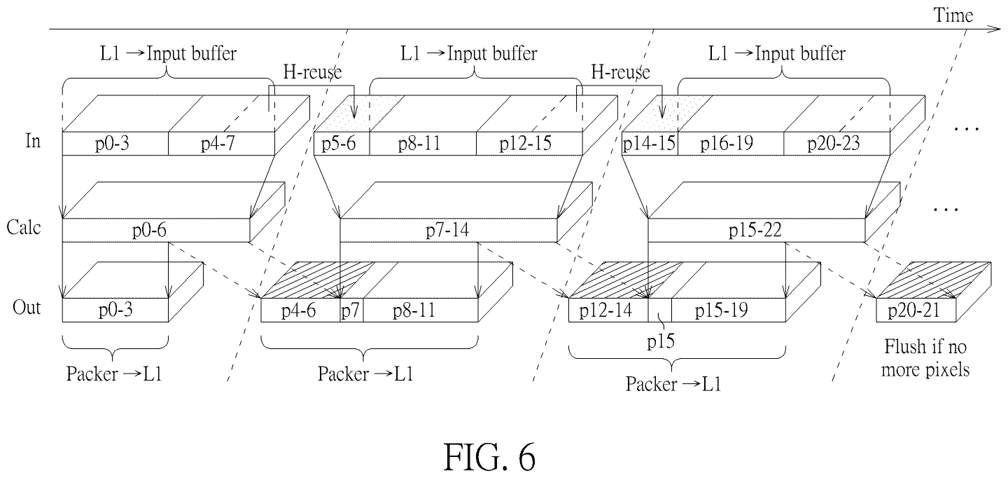

FIG. 6 illustrates the 3×3 convolution line processing workflow with local reuse according to an embodiment. The diagram demonstrates how the h-reuse cache mechanism reduces memory access by storing boundary pixels between adjacent spatial segments during line-based processing.

The workflow shows the temporal progression of processing a line of data through three main stages: input (In), calculation (Calc), and output (Out). The horizontal axis represents time progression, showing how different pixel segments are processed sequentially while maintaining data reuse efficiency. The input stage shows data flows from the L1 memory to input buffers, with specific pixel segments labeled as p0-3, p4-7, p5-6, p8-11, p12-15, p14-15, p16-19, and p20-23. These segments represent overlapping windows of pixels that are processed by the 3×3 convolution operation.

The H-reuse cache mechanism shows where boundary pixels are stored locally to avoid redundant memory access. For example, when processing segment p4-7, the H-reuse cache retains boundary pixels that will be needed for the subsequent segment p8-11. This caching approach is particularly effective because 3×3 convolutions require overlapping input data from neighboring spatial positions. The cache stores the overlapping regions (such as pixels p5-6 that span between segments p0-3 and p4-7) locally, eliminating the need to re-read these pixels from the L1 memory.

The calculation stage shows how the MAC array processes these segments, with operations labeled as p0-6, p7-14, and p15-22. These calculation windows demonstrate the processing segments are slightly larger than the input segments due to the convolution kernel requirements. The overlapping nature of these calculation segments is enabled by the H-reuse cache providing the necessary boundary pixels without additional memory access.

The output stage illustrates that processed results are formatted and sent back to memory through the packer mechanism. Output segments p0-3, p4-6, p7, p8-11, p12-14, p15, p15-19, and p20-21 show the final processed pixels that are written back to the L1 memory. The workflow includes a “flush if no more pixels” indication, showing the system handles the end of line processing to ensure all remaining data is properly output.

This line processing workflow with local reuse demonstrates memory access reduction compared to conventional approaches. By caching boundary pixels locally, the system avoids redundant reads from the L1 memory that would otherwise be required for overlapping regions in 3×3 convolutions. The temporal organization shows how continuous processing is maintained through careful coordination of input buffering, local caching, computation, and output packing stages.

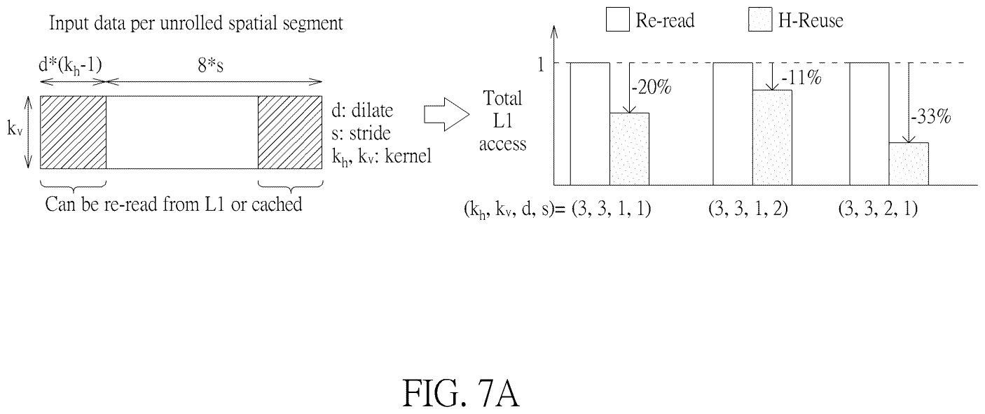

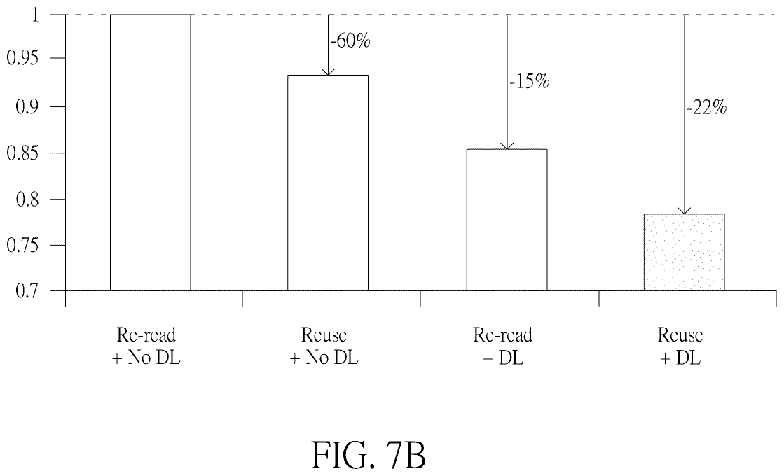

FIG. 7A illustrates the effectiveness of H-reuse caching compared to re-reading data from L1 memory, showing quantified performance improvements for different convolution operation configurations.

The left side of the figure illustrates the spatial data organization for convolution processing, showing input data structure per unrolled spatial segment. The diagram shows a data segment of width d*(kh−1) with 8*s spatial elements, where the boundaries represent overlapping regions that can either be re-read from L1 memory or retrieved from the H-reuse cache. The parameters d, s, kₕ, and kᵥ represent dilation, stride, and kernel dimensions respectively. The overlapping boundary regions can be efficiently cached locally rather than repeatedly accessed from the primary L1 memory.

The right side presents quantified performance results comparing total L1 access between conventional re-reading approaches and the H-reuse caching method. Three different convolution configurations are evaluated: (kₕ, kᵥ, d, s)=(3, 3, 1, 1), (3, 3, 1, 2), and (3, 3, 2, 1), representing different combinations of kernel sizes, dilation rates, and stride values. For the (3, 3, 1, 1) configuration, H-reuse caching achieves a 20% reduction in total L1 access compared to re-reading. The (3, 3, 1, 2) configuration shows an 11% improvement, whereas the (3, 3, 2, 1) configuration shows the benefit with a 33% reduction in L1 access.

The results demonstrate that H-reuse caching is particularly effective for operations with different stride and dilation patterns. The 33% improvement for the (3,3,2,1) configuration indicates that dilated convolutions benefit from boundary pixel caching due to their sparse access patterns. The varying improvement percentages across different configurations reveal the adaptive nature of H-reuse cache performance across different convolution parameter sets, with more benefits observed for operations that have higher degrees of spatial overlap or more complex access patterns.

The area overhead for implementing the H-reuse cache is approximately 2.3% of the total chip area, showing a minimal hardware cost for substantial performance gains. There are two additional benefits. First, the latency becomes less bounded by on-chip bandwidth due to reduced L1 memory contention. Second, more on-chip bandwidth becomes available for the direct link path between processing units. This freed-up bandwidth enables the concurrent execution of convolution and element-wise operations that contributes to the overall 22% latency reduction achieved by the combined H-reuse and direct link architecture. The H-reuse caching mechanism thus can be an efficient trade-off between modest area overhead and memory access optimization, particularly beneficial for bandwidth-constrained scenarios common in edge device implementations.

FIG. 7B illustrates latency reduce with H-reuse cache and direct link that demonstrate the combined performance benefits of both H-reuse caching and direct link architecture. The bar chart compares four different system configurations: re-read without direct link (Re-read+No DL), H-reuse without direct link (Reuse+No DL), re-read with direct link (Re-read+DL), and H-reuse with direct link (Reuse+DL). The normalized latency values range from approximately 1.0 for the baseline configuration down to approximately 0.78 for the optimized configuration.

The results show progressive latency improvements as optimizations are added. The H-reuse cache alone (without direct link) provides a 6% latency reduction compared to the baseline re-read approach. The direct link alone (without H-reuse) achieves a 15% latency improvement over the baseline. The combined implementation of both H-reuse caching and direct link delivers the maximum benefit with a 22% total latency reduction.

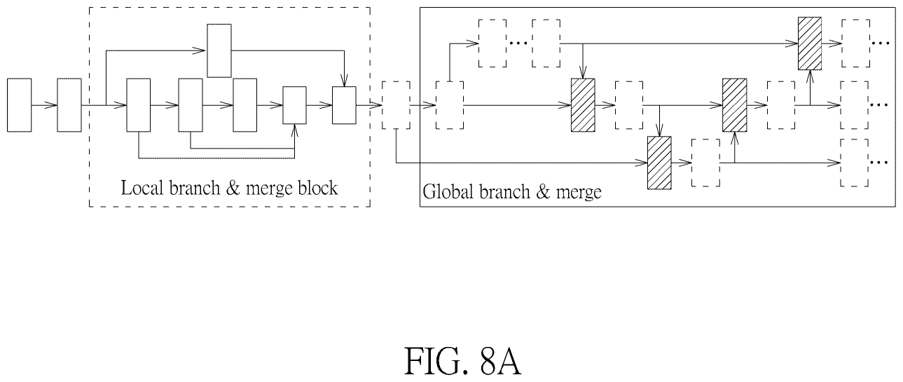

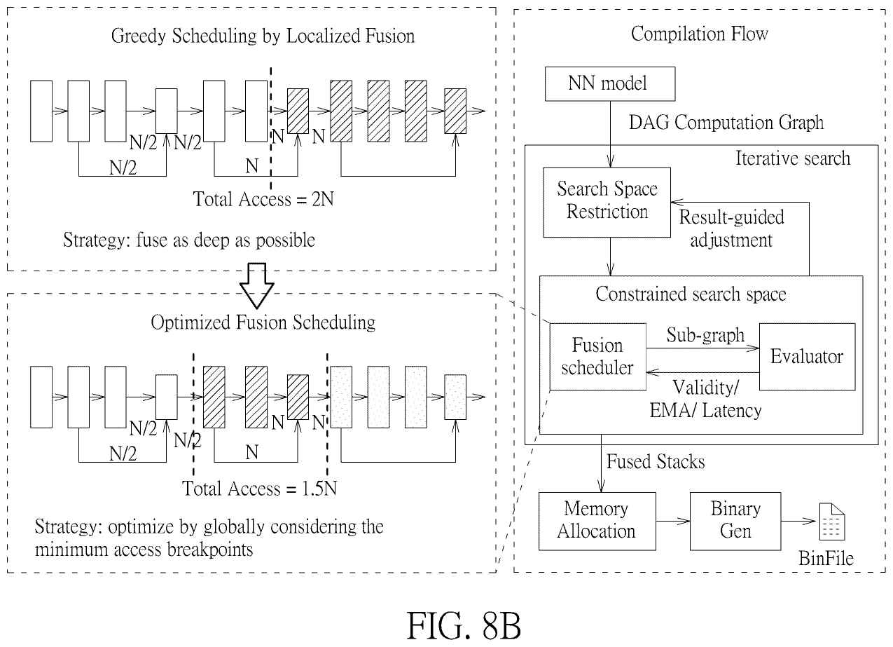

FIG. 8A illustrates the scheduling of a DNN model with multiple branches that presents the optimization challenges faced when determining efficient execution strategies for complex neural network topologies with branching patterns. The figure displays a representative deep neural network (DNN) architecture that contains both local and global branching structures. The local branch and merge block (at the left) represents a common pattern in modern neural networks where data flows through multiple parallel paths before converging. This local branching pattern includes several processing blocks connected through both direct sequential paths and bypass connections, demonstrating the type of residual or skip connections commonly found in architectures like ResNet or similar designs. The blocks within this section show various interconnection patterns including parallel processing paths that merge at specific points.

The global branch and merge block (at the right) represents longer-range branching behavior where data paths diverge early in the network and reconverge after passing through multiple intermediate processing stages. The global branching structure reveals that the network topology can become more complex when multiple branching points are distributed throughout the architecture. The optimization challenge involves finding a network partition that minimizes memory access and latency, representing the fundamental problem that scheduling systems must address when processing complex network topologies. The challenge is compounded by two factors. First, as the number of branching points increases, the computational complexity of finding optimal scheduling solutions increases exponentially, making brute-force optimization approaches impractical for real-world neural networks. Second, the optimization problem involves balancing two potentially competing objectives: minimizing external memory access (EMA) and reducing latency.

FIG. 8B illustrates the scheduling optimization method according to an embodiment. The method addresses the complex branching challenges shown in FIG. 8A. Greedy scheduling by localized fusion represents a conventional approach to layer fusion optimization. The diagram displays a sequence of processing blocks with local fusion boundaries, where operations are grouped into fused segments (N/2, N) based on localized optimization decisions. The greedy scheduling follows the strategy of “fuse as deep as possible” within local regions, attempting to maximize the number of layers that can be fused together in each segment. However, this approach results in a total access=2N for memory operations.

In contrast, optimized fusion scheduling demonstrates the improved scheduling method which creates a different fusion pattern with segments of varying sizes, resulting in total access=1.5N. This represents a 25% reduction in memory access compared to the greedy scheduling. The optimized fusion scheduling employs the strategy to optimize by globally considering the minimum access breakpoints, indicating that fusion decisions are made based on global analysis of the entire network rather than local optimization. This global consideration enables the optimal breakpoints to be identified that minimize overall memory access across the complete execution sequence.

The compilation flow, implemented by the optimized scheduling, begins with an NN model input that undergoes DAG computation graph analysis to understand the network structure and dependencies. Search space restriction with iterative search and result-guided adjustment are implemented to manage the exponential complexity of the optimization problem. This iterative approach progressively refines the search space based on intermediate results, making the optimization computationally tractable for complex networks.

Within the constrained search space, a fusion scheduler operating on sub-graphs is used to evaluate different fusion possibilities. An evaluator component assesses the validity/EMA/latency of each potential fusion configuration, providing that proposed method meet hardware constraints while optimizing for both external memory access and execution latency. The evaluation process considers multiple objectives simultaneously, balancing the trade-offs between memory efficiency and performance.

The compilation flow concludes with fused stacks generation, followed by memory allocation optimization and binary generation (Binary Gen) that produces the binary file (BinFile) for execution on the target hardware. The memory allocation component provides that the fused operations can be executed within the available on-chip memory constraints, and the binary generation creates the executable instructions that implement the optimized scheduling decisions.

This comprehensive optimization framework addresses the exponential search space problem identified in FIG. 8A by using constrained search techniques and iterative refinement. The outcome is a practical solution that can handle complex neural network topologies with multiple branches while achieving improvements in memory access efficiency compared to conventional greedy scheduling.

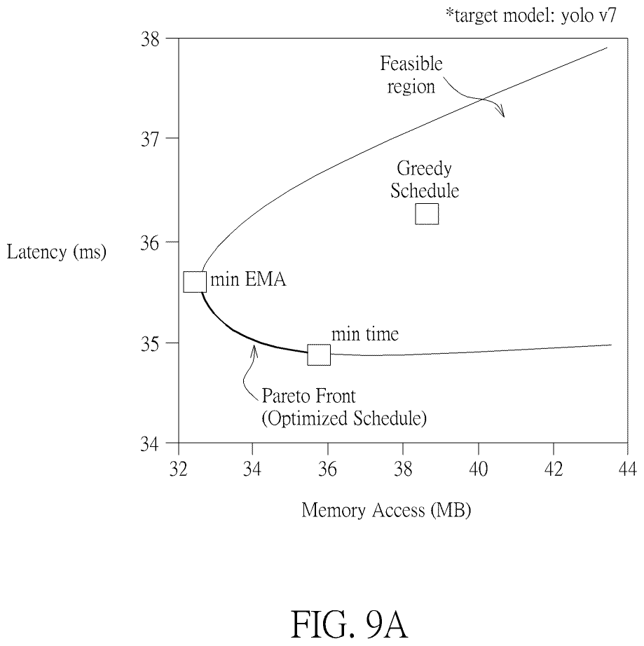

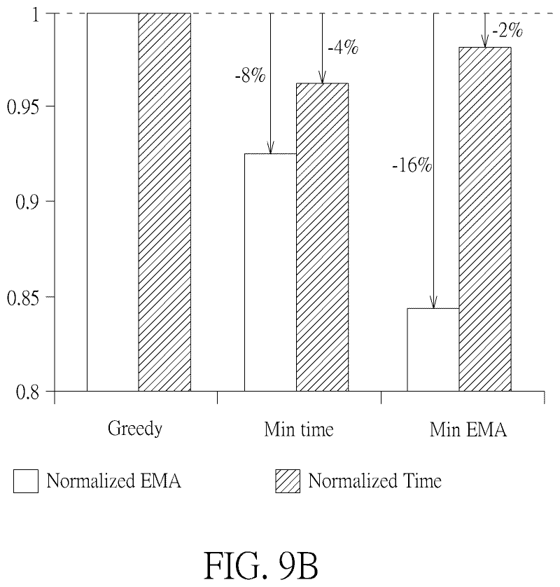

FIGS. 9A and 9B illustrate the effectiveness of the optimized fusion scheduling with the feasible operating region and quantified performance improvements achieved through the optimized fusion scheduling.

FIG. 9A illustrates the EMA-latency feasible region analysis using YOLO v7 as the target model. The plot shows latency (ms) on the vertical axis ranging from 34 to 38, and memory access (MB) on the horizontal axis ranging from 32 to 44. The region within the curve represents the feasible region where valid scheduling solutions can be implemented within the hardware constraints of the system. A curved boundary line defines the upper limit of this feasible region, indicating the trade-off relationship between memory access and latency for different scheduling approaches.

Three distinct operating points are marked on the plot to illustrate different scheduling strategies. The greedy schedule point is positioned within the feasible region but represents a suboptimal solution for both memory access and latency performance. The minimum EMA point indicates the scheduling configuration that minimizes external memory access, positioned at the leftmost boundary of the feasible region with the lowest memory access requirements but potentially higher latency. The minimum time point represents the scheduling configuration optimized for minimum latency, located at a position that achieves the fastest execution time while maintaining acceptable memory access levels.

The Pareto front (optimized schedule) curve connects the optimal operating points and demonstrates the range of efficient scheduling solutions available through the above-mentioned optimization approach. The Pareto front represents the set of non-dominated solutions where improvement in one objective (EMA or latency) cannot be achieved without degrading the other objective. The optimization algorithm can select any point along this Pareto front depending on the specific requirements and priorities of the target application.

FIG. 9B provides quantified EMA and latency improvements comparing three scheduling approaches: greedy scheduling, minimum time, and minimum EMA. The bar chart shows normalized performance metrics where baseline values represent 1.0. Two sets of bars are presented for each approach: normalized EMA and normalized time.

The greedy scheduling approach serves as the baseline reference point with both normalized EMA and normalized time at approximately 1.0. The minimum time scheduling configuration achieves an 8% improvement in latency (normalized time) and a 4% improvement in EMA compared to the greedy approach. The minimum EMA scheduling configuration delivers more substantial improvements with a 16% reduction in external memory access and a 2% improvement in latency performance.

The results demonstrate that the optimized scheduling approach provides benefits over conventional greedy scheduling. The minimum EMA configuration is particularly effective for memory-constrained scenarios common in edge device implementations, achieving substantial memory access reduction while maintaining competitive latency performance. The minimum time configuration offers balanced improvements in both metrics, making it suitable for applications where execution speed is the primary concern but memory efficiency remains important. In addition, the ability to select different points along the Pareto front provides system designers with flexibility to optimize for specific application requirements and hardware constraints. This multi-objective optimization capability represents advancement over traditional scheduling approaches that typically optimize for a single objective without considering the trade-offs between memory access and execution latency.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art. As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A heterogeneous neural processing system comprising:
a first processor configured to execute an encoding operation and a decoding operation of an autoencoder; and
a second processor configured to execute a task-specific neural network operation that performs iterative processing;
wherein the first processor and the second processor execute computational tasks with synchronized data exchange to implement a generative AI model.

2. The system of claim 1, wherein the encoding operation transforms input data into latent representations and the decoding operation reconstructs latent representations back into output data.

3. The system of claim 1, wherein the first processor executes the encoding operation and the decoding operation while the second processor concurrently executes the task-specific neural network operation on data of the same generative AI model.

4. The system of claim 1, wherein the first processor is further configured to:
process feature maps of a neural network divided into a plurality of lines of data;
cache the plurality of lines of data in an activation memory; and
determine whether a required portion of the plurality of lines of data are cache in the activation memory and select operations that are deeper in a network hierarchy.

5. The system of claim 4, wherein the neural network comprises branched inputs, branched outputs, and residual connections processed within a fused layer stack.

6. The system of claim 4, wherein the first processor is further configured to assign memory addresses for cached lines of data having different heights and overlapping live ranges.

7. The system of claim 1, wherein the first processor comprises an H-reuse cache configured to store boundary pixels between adjacent spatial segments.

8. The system of claim 7, wherein the first processor is further configured to execute a convolution and an element-wise operation concurrently, and the element-wise operation comprise addition and/or concatenation.

9. The system of claim 7, wherein the first processor further comprises ping-pong buffers configured to fetch a next data segment while a current segment is being processed.

10. The system of claim 7, wherein the H-reuse cache stores boundary pixels between spatial segments having kernel dimensions, dilation rate, and stride.

11. The system of claim 1, further comprising a neural network conditioning device configured to:
analyze a neural network model to identify layer dependencies and fusion boundaries;
apply constraints to a search space based on memory capacity and processing capacity to define fusion configurations;
perform an iterative search within the search space to generate a plurality of fusion schedules; and
select a fusion schedule from the plurality of fusion schedules based on external memory access and execution latency.

12. The system of claim 11, wherein the neural network conditioning device is further configured to limit branching factors and fusion depth.

13. The system of claim 11, wherein the neural network conditioning device is further configured to generate a plurality of fusion configurations and select a configuration of the plurality of fusion configurations based on external memory access and execution latency.

14. The system of claim 11, wherein the neural network conditioning device is further configured to assign activation memory addresses for operations having different data heights and non-overlapping temporal execution windows.

15. The system of claim 11, wherein the neural network conditioning device is further configured to process neural network topologies having skip connections and residual connections.

16. The system of claim 1, wherein the task-specific neural network operation comprises denoising operations performed by a U-Net architecture.

17. The system of claim 1, wherein the task-specific neural network operation comprises a conditioning operation that encodes semantic vectors or textual token embeddings into latent space representations.

18. The system of claim 1, wherein the task-specific neural network operation comprises attention mechanisms having query, key, and value components.

19. The system of claim 1, wherein the generative AI model comprises a latent diffusion model for text-to-image generation.

20. The system of claim 1, wherein the generative AI model comprises an image restoration model for super-resolution or face restoration.
